(19) United States
(12) Patent Application Publication
(10) Pub. No.: US 2023/0360034 A1
(43) Pub. Date: Nov. 9, 2023

(54) PROFILE BADGES AND ACCESS CONTROL BASED ON DIGITAL WALLET BLOCKCHAIN ACTIVITY

(71) Applicant: Unstoppable Domains, Inc., Las Vegas, NV (US)

(72) Inventors: Lisa Seacat DeLuca, Bozeman, MT (US); Michael Vandon Williams, Raleigh, NC (US)

(21) Appl. No.: 17/736,252

(22) Filed: May 4, 2022

(51) Int. Cl. G06Q 20/36; G06Q 20/06; H04L 9/00; H04L 67/306; G06Q 20/38

(52) U.S. Cl. CPC G06Q 20/3678; G06Q 20/3674; G06Q 20/065; H04L 9/50; H04L 67/306; G06Q 20/363; G06Q 20/3821; G06Q 2220/10; H04L 2209/56

(57) ABSTRACT

According to a present invention embodiment, a system for monitoring blockchain activity comprises one or more memories and at least one processor coupled to the one or more memories. A wallet is determined to be associated with a user has engaged in a transaction on a blockchain. A badge of a plurality of badges is identified based on the transaction. A profile of the user is updated to include the badge to indicate a user status for activity on the blockchain. Embodiments of the present invention further include a method and computer program product for monitoring blockchain activity in substantially the same manner described above.

### BACKGROUND

### 1. Technical Field

Present invention embodiments relate to tracking digital wallet activity for a user to create, modify, or remove user profile data for a digital identity of the user. Furthermore, the presence of the profile badge can be used for data access control, and more specifically, to controlling access to computing resources based on the presence of the profile badge based on digital wallet activity and blockchain events.

### 2. Discussion of the Related Art

A cryptocurrency wallet is a form of digital wallet that enables a user to send, store, and receive cryptocurrency tokens, including fungible tokens (e.g., Bitcoins) and/or non-fungible tokens (NFTs). As NFTs grow in popularity, NFTs are increasingly seen as a status symbol for those who own them. As such, users may desire to showcase their NFTs to others in a manner that provides easy proof of ownership.

### SUMMARY

According to one embodiment of the present invention, a system for monitoring blockchain activity comprises one or more memories and at least one processor coupled to the one or more memories. A wallet is determined to be associated with a user has engaged in a transaction on a blockchain. A badge of a plurality of badges is identified based on the transaction. A profile of the user is updated to include the badge to indicate a user status for activity on the blockchain. Embodiments of the present invention further include a method and computer program product (e.g., including one or more computer readable media with executable instructions) for monitoring blockchain activity in substantially the same manner described above.

### BRIEF DESCRIPTION OF THE DRAWINGS

Generally, like reference numerals in the various figures are utilized to designate like components.

FIG. 1 is a diagrammatic illustration of an example computing environment according to an embodiment of the present invention.

FIG. 2 is a block diagram of an example computing device according to an embodiment of the present invention.

FIG. 3 is a schematic illustration of an example graphical user interface for displaying badges to a service according to an embodiment of the present invention.

FIG. 4 is a schematic illustration of an example graphical user interface for displaying a user profile according to an embodiment of the present invention.

FIG. 5 is a schematic illustration of an example graphical user interface for displaying wallet activity according to an embodiment of the present invention.

FIG. 6 is a schematic illustration of an example graphical user interface for displaying a user profile according to an embodiment of the present invention.

FIG. 7 is a flowchart of a method of managing user badges according to an embodiment of the present invention.

FIG. 8 is a flowchart of a method of authorizing user access to a computing resource according to an embodiment of the present invention.

### DETAILED DESCRIPTION

An embodiment of the present invention relates to analyzing a user's digital wallet transactions to provide badges based on the wallet's content that can be used for a variety of applications. The wallet can include fungible tokens, such as cryptocurrency coins (e.g., Bitcoins), and/or non-fungible tokens (NFTs), which are not interchangeable with each other. An NFT is a unit of data, stored on a digital ledger (e.g., a blockchain), which can be bought, sold, and traded. Each NFT can be associated with a particular digital or physical asset such as visual art, literature, music, and other media, and NFTs can convey a license to use the asset for a specified purpose. Since each NFT is unique, NFTs can serve as status symbols, and NFT ownership has become a pursuit among many. While a user can prove ownership of an NFT via their wallet, it is desirable to provide a simpler mechanism to display owned NFTs, such as a web-based user profile.

Accordingly, present invention embodiments enable a user to display his or her owned NFTs by linking a wallet of the user to the user's profile. The user's profile can be a web-based profile that is accessible via a browser, enabling other users to easily browse the user's NFT collection. In particular, badges may be provided on the user's profile that represent ownership of NFTs. Each badge may be a visual interface element that indicates some activity related to a user's NFT ownership. A badge can simply indicate that a user owns a particular NFT, or a badge can indicate that a user owns a certain amount or type of NFTs. For example, a badge might indicate that a user owns five, ten, or fifty NFTs of a particular collection. It should be appreciated that the badges can represent other aspects of a user's activity, such as a user's milestones (e.g., video game achievements, points accumulated on a message board, number of posts to a message board, number of blog articles published, number of followers, etc.), ownership of other tokens (e.g., cryptocurrency coins), and the like.

Additionally, since badges can be securely tied to a user's wallet activity, the badges can be used to authenticate the user for a variety of purposes without needing to access a blockchain. For example, a user can be admitted to a restricted section of a website based on the user's badges. As another example, a user may be permitted to access media associated with an NFT by using a badge to prove that the user owns that particular NFT. Thus, present invention embodiments improve the technical fields of information science and cybersecurity by providing an improved approach to controlling access to computing resources based on token ownership.

Further, present invention embodiments utilize a unique approach to monitoring wallet transactions. In particular, the functioning of a computer is improved by centralizing the tracking of wallet transactions in a trustworthy manner. Thus, present embodiments remove the need for individual third-party services to separately dedicate processing resources, memory resources, and/or storage resources that would otherwise be required to access a blockchain in order to verify token ownership. However, as the tokens are ultimately stored to a blockchain, the user data is immutably stored, thereby providing both security and data resilience. Accordingly, present invention embodiments improve the functioning of a computer by making inefficient blockchain operations unnecessary, while also providing the practical effect of making a user's token ownership easily accessible by others without the need for specialized software.

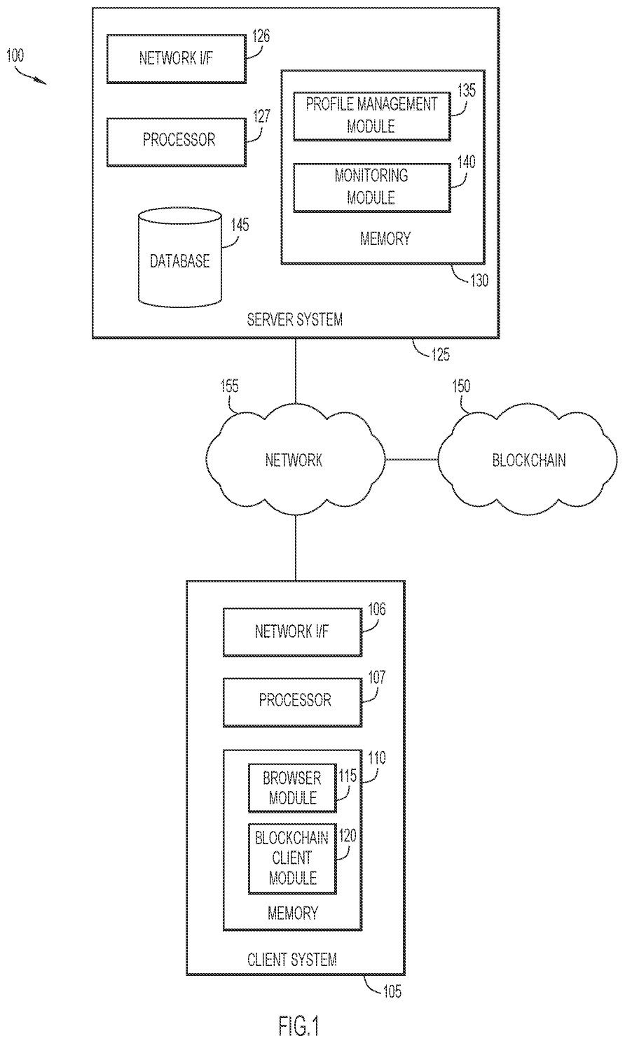

Present invention embodiments will now be described in detail with reference to the Figures. FIG. 1 is a diagrammatic illustration of an example computing environment 100 in accordance with an embodiment of the present invention. As depicted, computing environment 100 includes a client system 105, a server system 125, a blockchain 150, and a network 155. It is to be understood that the functional division among components of computing environment 100 have been chosen for purposes of explaining present invention embodiments and is not to be construed as a limiting example.

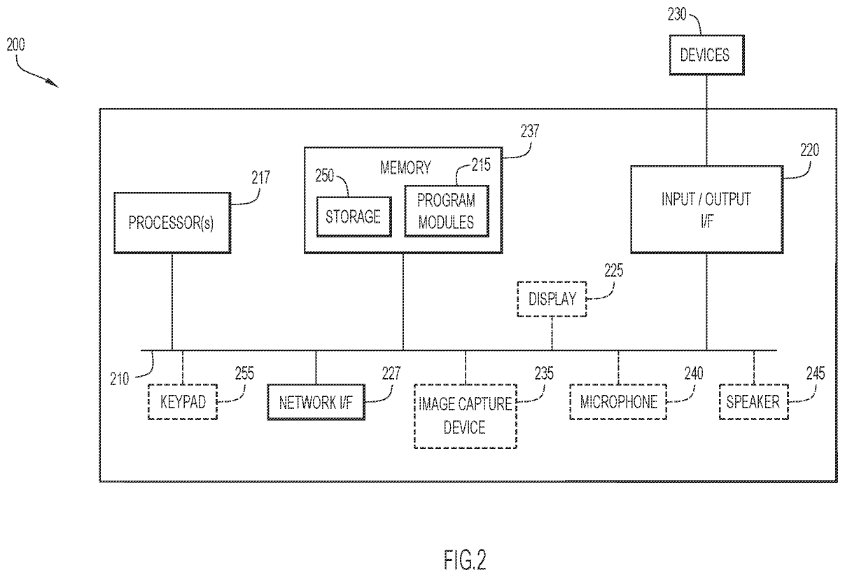

Client system 105 includes a network interface (I/F) 106, at least one processor 107, and memory 110. Memory 110 includes a browser module 115 and a blockchain client module 120. Client system 105 may include a laptop computer, a tablet computer, a netbook computer, a personal computer (PC), a desktop computer, a personal digital assistant (PDA), a smart phone, a thin client, or any programmable electronic device capable of executing computer readable program instructions. Network interface 106 enables components of client system 105 to send and receive data over a network, such as network 155. In general, client system 105 enables a user to perform various operations in accordance with present invention embodiments, including, but not limited to, performing blockchain transactions, accessing computing resources, viewing user profiles, and other operations. Client system 105 may include internal and external hardware components, as depicted and described in further detail with respect to FIG. 2.

Browser module 115 and blockchain client module 120 may include one or more modules or units to perform various functions of present invention embodiments described below. Browser module 115 and blockchain client module 120 may be implemented by any combination of any quantity of software and/or hardware modules or units, and may reside within memory 110 of client system 105 for execution by a processor, such as processor 107.

Browser module 115 enables a user of client system 105 to access computing networks such as the Internet. In some embodiments, browser module 115 is a web browser through which a user may access web content. In various other embodiments, browser module 115 may include any client (e.g., smartphone application, etc.) that can access server system 125 and/or other computing systems using, e.g., an application programming interface (API) or other interface. Browser module 115 enables a user to view the user's profile and/or profiles of other users, so that the user can see badges that are associated with user accounts in accordance with present embodiments. A user of client system 105 may also manage his or her user profile using browser module 115. For example, a user may add, remove, or update social media accounts associated with the user's profile, the user may provide bibliographical data (e.g., name, location, etc.), the user may provide links to blog posts, and the like. Additionally, browser module 115 enables a user to access secured computing resources when the user's access is determined to be authorized (e.g., based on the presence or absence of one or more badges on the user's profile).

Blockchain client module 120 manages one or more wallets of a user and provides a user interface through which a user may initiate blockchain transactions. In some embodiments, blockchain client module 120 enables client system 105 to serve as a node in a blockchain (e.g., blockchain 150) in addition to enabling a user to engage in blockchain transactions. Blockchain client module 120 may manage multiple wallets that correspond to a same or different blockchains; for example, blockchain client module 120 may manage a first wallet that stores a first set of tokens (e.g., fungible cryptocurrency coins), and blockchain client module 120 may manage a second wallet that stores a second set of tokens (e.g., NFTs).

Blockchain client module 120 performs blockchain transactions in response to user input requesting one or more tokens to be sent and/or in response to one or more tokens being received from another wallet. Thus, either the user or another user (or automated process) initiates a transaction. When the transaction is requested, a block representing that transaction is created by the initiating party (e.g., client system 105 or a remote system). The block is sent to the nodes in the blockchain network, which validate the transaction, and add the block to the existing blockchain, by distributing the update across the network. Thus, the new block provides an immutable entry proving that the user has either sent or received one or more tokens, thereby establishing ownership of tokens.

Additionally or alternatively, blockchain client module 120 enables a user to mint new tokens (e.g., NFTs). Initially, a user may obtain or create an item, such as an image, text, or other media. The item is then uploaded to an off-chain storage database and associated with an NFT, which is added to the user's wallet via a transaction that functions similarly to the user sending or receiving a fungible token. Thus, the blockchain is updated with a block that indicates that the user's wallet includes the newly-minted NFT.

Server system 125 includes a network interface (I/F) 126, at least one processor 127, memory 130, and a database 145. Memory 130 includes a profile management module 135 and a monitoring module 140. Server system 125 may include a laptop computer, a tablet computer, a netbook computer, a personal computer (PC), a desktop computer, a personal digital assistant (PDA), a smart phone, a thin client, a rack-mounted server, or any programmable electronic device capable of executing computer readable program instructions. Network interface 126 enables components of server system 125 to send and receive data over a network, such as network 155. Server system 125 may include internal and external hardware components, as depicted and described in further detail with respect to FIG. 2.

In general, server system 125 and its components enable users to access, manage, and store user profile data. Additionally or alternatively, server system 125 processes requests for user data from requesting entities that request badge data of users (e.g., an inventory of badges currently and/or previously held by a user). The software components of server system 125, which include profile management module 135 and monitoring module 140, may themselves include one or more modules or units to perform various functions of present invention embodiments described below. Profile management module 135 and monitoring module 140 may be implemented by any combination of any quantity of software and/or hardware modules or units, and may reside within memory 130 of server system 125 for execution by a processor, such as processor 127.

Profile management module 135 manages user profiles by adding, modifying, and/or removing badges from a user's profile based on the occurrence of blockchain transactions. Additionally, profile management module 135 can manage other data associated with a user's profile, such as the user's name and other bibliographical data, and can add, modify, and/or remove content to or from the user's profile in response to user input.

Profile management module 135 may operate in conjunction with monitoring module 140, which monitors any wallets associated with a user for activity (e.g., blockchain transactions). When monitoring module 140 determines that a user has received a new NFT, profile management module 135 can associate a badge with the user's profile. When monitoring module 140 determines that a user has transferred an existing NFT to another wallet, thereby transferring ownership to another user, profile management module 135 can remove or grey-out a badge.

In some embodiments, profile management module 135 can add, modify, and/or remove badges when any desired condition is satisfied. A badge can be added to indicate a user's ownership of an NFT, and removed (or greyed out) when the user no longer owns the NFT. A badge can be added that indicates the user owns a particular number of NFTs, either generally or as part of a set of NFTs having a common thematic or other relationship. For example, a badge may indicate that a user's wallet contains five, ten, or fifteen NFTs belonging to a particular collection. The conditions can apply to one wallet or to multiple wallets collectively, e.g., to enable conditions to be satisfied in cases in which a user owns different NFTs across several wallets.

A badge can represent user activity or accomplishments, such as the user's participation in a time-limited event, the user achieving a certain score in a video game, the user having a certain number of followers, the user's account being a certain age, the user owning a token that is worth a particular monetary value, the user's tokens collectively being worth a particular monetary value, and the like. A badge can be added to represent that the user has proven their identity to a service (e.g., to indicate that the user is verified).

Badges can also indicate the status of NFTs with respect to a user. In particular, badges can indicate whether the user currently owns the NFT, previously owned the NFT, minted the NFT, and the like. Badges can indicate status using a color scheme (e.g., by associating a particular color with a status), or badges can be grouped by status (e.g., by providing a currently-owned section, previously-owned section, user-minted section, etc.).

Additionally, profile management module 135 manages other aspects of a user's profile based on user input. A user of client system 105 may, via browser module 115, provide instructions to profile management module 135 to cause the user's profile to be modified. In various embodiments, a user can edit bibliographical data, add, modify, and/or remove any other social media or other accounts that the user desires to be associated with the user's profile, add, modify, and/or remove receiving addresses for the user's wallet(s), add hyperlinks to the user's website, email address, or blog posts, and the like.

Monitoring module 140 may monitor any wallets associated with a user to detect blockchain transactions. When a user registers an account with server system 125, the user may provide the addresses of any wallets that the user wishes to register with their account. Monitoring module 140 can then analyze a blockchain to identify any transactions in which the user's wallet participated. When monitoring module 140 identifies a transaction involving a wallet of a user, monitoring module 140 can inform profile management module 135, which can then determine whether the transaction causes a condition to be satisfied, and if so, add, modify, or remove a badge accordingly. Thus, monitoring module 140 may indicate to profile management module 135 that a user's wallet sent or received an NFT, passing along any details relating to the transaction (e.g., identity of the NFT, amount and/or identity of any other tokens involved in the transaction, etc.).

Monitoring module 140 can identify transactions in a blockchain by determining whether each transaction involves an address associated with a wallet that is associated with a user registered with server system 125. Monitoring module 140 may identify blockchain transactions involving a wallet accordingly to a particular schedule, in real-time, and/or on an ad hoc basis. In some embodiments, monitoring module 140 follows an assigned schedule in which a blockchain is periodically analyzed to identify transactions involving users' wallets. For example, monitoring module 140 may check a blockchain every hour, every minute, every day, etc. In some embodiments, monitoring module 140 may analyze a blockchain in real-time (e.g., as often as is possible given network and/or processing constraints) to detect new blocks close in time to when the new blocks are made. Thus, monitoring module 140 can identify transactions involving users' wallets soon after the transaction finalizes (e.g., when blockchain consensus is reached). In some embodiments, monitoring module 140 analyzes a blockchain on an ad hoc basis based on an instruction to analyze the blockchain. For example, monitoring module 140 may analyze a blockchain when a user creates a new account, adds a new wallet, and/or requests the user's profile to be updated. It should be appreciated that monitoring module 140 may not analyze an entire blockchain, but instead may analyze only the blocks that have been added since a previous analysis of the blockchain.

Database 145 may include any non-volatile storage media known in the art. For example, database 145 can be implemented with a tape library, optical library, one or more independent hard disk drives, or multiple hard disk drives in a redundant array of independent disks (RAID). Similarly, data in database 145 may conform to any suitable storage architecture known in the art, such as a file, a relational database, an object-oriented database, and/or one or more tables. Database 145 may store data that includes user profile data, wallet addresses, badges associated with each user account, statuses of each badge, and other data.

Blockchain 150 is a distributed data ledger that is supported by a peer-to-peer network of computing devices. As such, blockchain 150 is a growing list of blocks that are cryptographically linked by providing a hash of the previous block, a time stamp, and transaction data. Blockchain 150 may be a public blockchain, a private blockchain, or a hybrid blockchain, and may support a variety of operations, including cryptocurrency exchange, smart contract execution, financial services, decentralized applications, and the like. The particular computing devices that compose the peer-to-peer network of blockchain 150 may include computing devices of environment 100 (e.g., client system 105 and server system 125) and/or may include other computing devices.

Network 155 may include a local area network (LAN), a wide area network (WAN) such as the Internet, or a combination of the two, and includes wired, wireless, or fiber optic connections. In general, network 155 can be any combination of connections and protocols known in the art that will support communications between client system 105, server system 125, and/or components of blockchain 150 via their respective network interfaces in accordance with embodiments of the present invention.

An example of a computing device 200 of environment 100 (e.g., implementing client system 105, server system 125, and/or any computing components that support blockchain 150) is illustrated in FIG. 2. The example computing device may perform the functions described herein. Computing device 200 may be implemented by any personal or other type of computer or processing system (e.g., desktop, laptop, hand-held device, smartphone or other mobile device, etc.), and may be used for any computing environments (e.g., cloud computing, client-server, network computing, mainframe, stand-alone systems, etc.).

Computing device 200 may include one or more processors 217 (e.g., microprocessor, controller, central processing unit (CPU), etc.), network interface 227, memory 237, a bus 210, and an Input/Output interface 220. Bus 210 couples these components for communication, and may be of any type of bus structure, including a memory bus or memory controller, a peripheral bus, and a processor or local bus using any of a variety of conventional or other bus architectures. Memory 237 is coupled to bus 210 and typically includes computer readable media including volatile media (e.g., random access memory (RAM), cache memory, etc.), non-volatile media, removable media, and/or non-removable media. For example, memory 237 may include storage 250 containing nonremovable, non-volatile magnetic or other media (e.g., a hard drive, etc.). The computing device may further include a magnetic disk drive and/or an optical disk drive (not shown) (e.g., CD-ROM, DVD-ROM or other optical media, etc.) connected to bus 210 via one or more data interfaces.

Moreover, memory 237 includes a set of program modules 215 (e.g., corresponding to browser module 115, blockchain client module 120, profile management module 135, monitoring module 140, etc.) that are configured to perform functions of present invention embodiments described herein. The memory may further include an operating system, at least one application and/or other modules, and corresponding data. These may provide an implementation of a networking environment.

Input/Output interface 220 is coupled to bus 210 and communicates with one or more peripheral or external devices 230 (e.g., a keyboard, mouse or other pointing device, a display, biometric sensing devices, etc.), at least one device that enables a user to interact with computing device 200, and/or any device (e.g., network card, modem, etc.) that enables computing device 200 to communicate with one or more other computing devices. Computing device 200 may communicate with one or more networks (e.g., a local area network (LAN), a wide area network (WAN), a public network (e.g., the Internet), etc.) via network interface 227 coupled to bus 210.

With respect to certain entities (e.g., client system 105, etc.), computing device 200 may further include, or be coupled to, a touch screen or other display 225, a camera or image capture device 235, a microphone or other sound sensing device 240, a speaker 245 to convey sound, and/or a keypad or keyboard 255 to enter information (e.g., alphanumeric information, etc.). These items may be coupled to bus 210 or Input/Output interface 220 to transfer data with other elements of computing device 200.

By way of example, present invention embodiments pertain to the use of blockchain transactions to support a badging system for users, which can be used to grant authorized access to computing resources. Initially, a blockchain is generally in the form of a ledger that includes a series of records or blocks chained or linked together. Each block includes a hash of the prior block in the blockchain, a timestamp, and transaction information. The hash of the prior block enables the blockchain to be resistant to modification since changes to data in any prior block alters the hash value which propagates to subsequent blocks.

A blockchain is typically managed by a peer-to-peer network and used as a distributed ledger. Nodes of the peer-to-peer network communicate and verify new blocks according to a protocol. The peer-to-peer network provides a decentralized approach, where each node has a copy of the blockchain. Transactions are transmitted to the network, where mining nodes process the transactions. The mining nodes validate a transaction, insert the transaction into a current block, and transmit the block to the other nodes. Various consensus approaches may be used for combining validation results of different mining nodes to determine validity of a transaction (or block). In addition, a blockchain may store software (e.g., typically referred to as smart contracts) that executes in response to occurrence of pre-defined conditions. A blockchain may be public (e.g., no access restrictions, etc.), private (e.g., restricted access, etc.), or hybrid (e.g., with centralized and de-centralized features).

Users of transactions for the blockchain are authenticated based on cryptographic keys. These keys identify a user and provide access to a user account or wallet. The user wallet is basically an application or software that enables users to store and access digital assets (e.g., for receiving or sending cryptocurrency or other fungible tokens, non-fungible tokens (NFT), etc.). For example, a non-fungible token (NFT) is a crypto-type asset with each token being unique (and representing items, such as digital art, music, or video game items), whereas fungible tokens (e.g., coins of the same cryptocurrency) have the same value of worth and are exchangeable. Each user is associated with their own private key (e.g., accessible only to the associated user, etc.) and a public key (e.g., typically an address on the blockchain). The private and public keys enable authentication of the user based on digital signatures in order to commence a transaction. The user account or wallet typically stores the private key.

For example, in order for the user to send cryptocurrency, a message for a transaction is encrypted with the private key of the user wallet. The private key enables only the user to control the user wallet. A digital signature is created by encrypting the message with the private key, where the digital signature is used to verify the user and transaction. The message may be decrypted with the corresponding public key of the user wallet. Since the private key is unique to the user, successful decryption of the message with the corresponding public key verifies the message was sent by the user. Once verified, the transaction may be posted to the blockchain, thereby adjusting the user wallet based on the transaction.

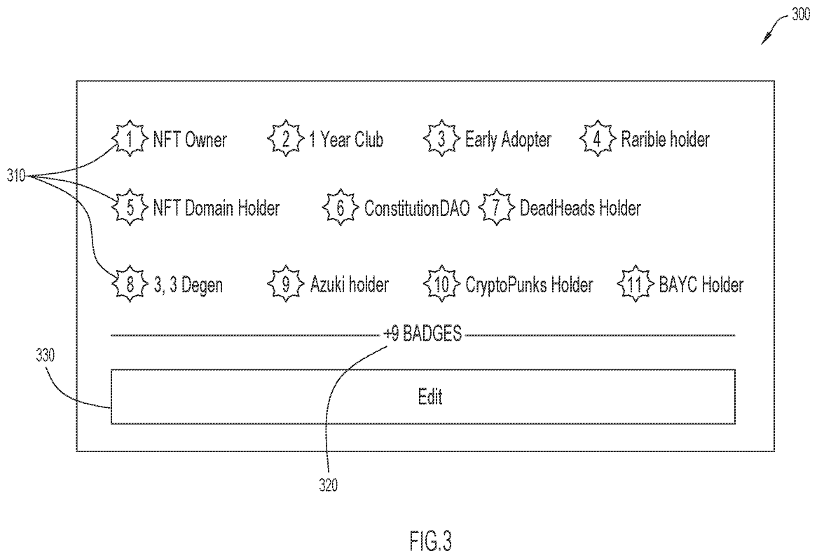

FIG. 3 is a schematic illustration of an example graphical user interface 300 for displaying badges to a service according to an embodiment of the present invention. Graphical user interface 300 may be a portion of another interface that corresponds to a profile of a user, or may be a stand-alone interface. As depicted, graphical user interface 300 includes a plurality of badges 310, an expansion element 320, and an edit element 330.

Each badge 310 may be a graphical element that can conform to any desired appearance. In various embodiments, badges 310 may include text characters (e.g., American Standard Code for Information interchange (ASCII) characters), emoji characters, images, and the like. In some embodiments, each badge may be unique in appearance, whereas in other embodiments, at least some of the badges may be substantially identical in appearance. Badges may be color-coded to convey additional details, such as a category of badge (e.g., corresponding to a particular set of NFTs) or a status of each badge (e.g., currently owned by a user, previously owned, minted, etc.). Each badge 310 may be associated with a particular condition, such as a user owning a particular NFT, a number of NFTs, and the like.

In some embodiments, some conditions may not have a particular badge 310 that is predefined, and so a default badge may be displayed. In some embodiments, the badge that is selected for display may be selected from a set of icons based on keyword matching. For example, if an NFT depicts a particular animal, which can be indicated by a name of the NFT (e.g., “giraffe”), then a giraffe icon may be selected from a set of animal icons. In some embodiments, a machine learning model may be trained to perform image classification, and an icon for a badge can be selected based on a classification of one or more objects that are recognized to be depicted in an NFT that includes one or more images.

Expansion element 320 may enable a user interacting with graphical user interface 300 to expand the display in order to view additional badges (e.g., the nine additional badges not currently depicted). Edit element 330 may enable a user to edit his or her displayed badges. In various embodiments, a user may reorder badges, toggle the display of badges on or off, and the like.

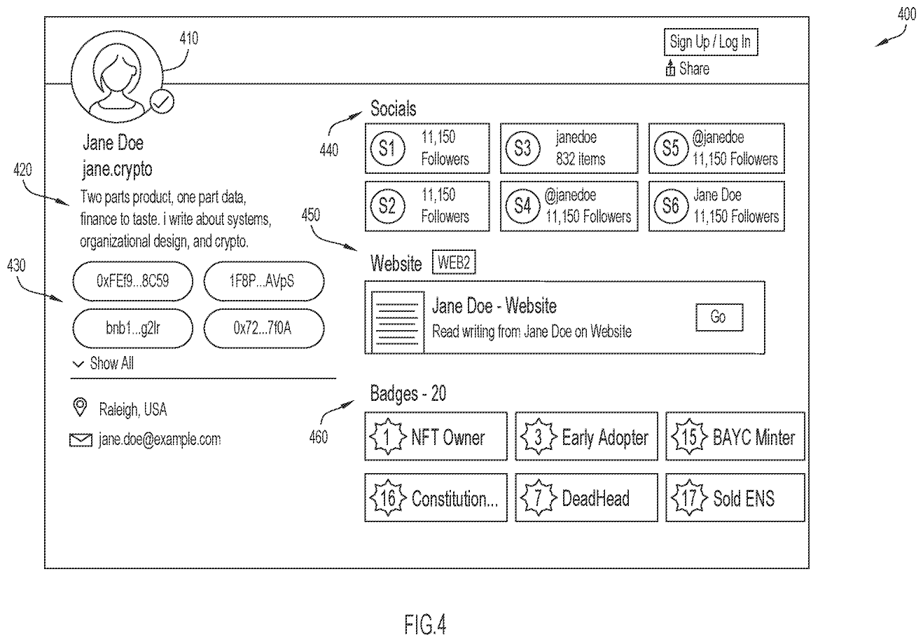

FIG. 4 is a schematic illustration of an example graphical user interface 400 for displaying a user profile according to an embodiment of the present invention. As depicted, graphical user interface 400 includes a user icon 410, a bibliographical section 420, wallet addresses 430, social media accounts 440, user website 450, and badges 460. Graphical user interface 400 may correspond to a view of a particular user's profile, in accordance with a present invention embodiment.

User icon 410 may include an avatar, photograph of the user, placeholder image, or any other desired representation of a user. In some embodiments, user icon 410 may include a checkmark or other feature to indicate that a user's identity has been verified. Bibliographical section 420 may include details that a user provides about the user, such as a custom description, background, education, and the like. Wallet addresses 430 may include one or more receiving addresses for one or more wallets, which the user may register with the user's profile, and which may be tracked in accordance with present embodiments in order to support a badging system.

Social media accounts 440 may include one or more social media accounts of the user. Each social media account 440 may include a hyperlink so that a user can activate a particular social media account 440 in a browser to cause the browser to navigate to the user's profile of that social media account. User website 450 may include a short description of a website (e.g., a title, initial text, etc.) and may similarly include a hyperlink that a user can activate to cause a browser to navigate to the user website.

Badges 460 may include any badges that the user has been assigned. In some embodiments, a subset of badges are displayed, and additional badges can be viewed by interacting with a user interface element. The displayed subset of badges may be defined by a user, or the displayed subset of badges may be selected based on an order in which the user obtained the badges. In some embodiments, badges 460 are displayed according to a predefined priority (e.g., each badge may be assigned a priority value and badges can be ranked accordingly).

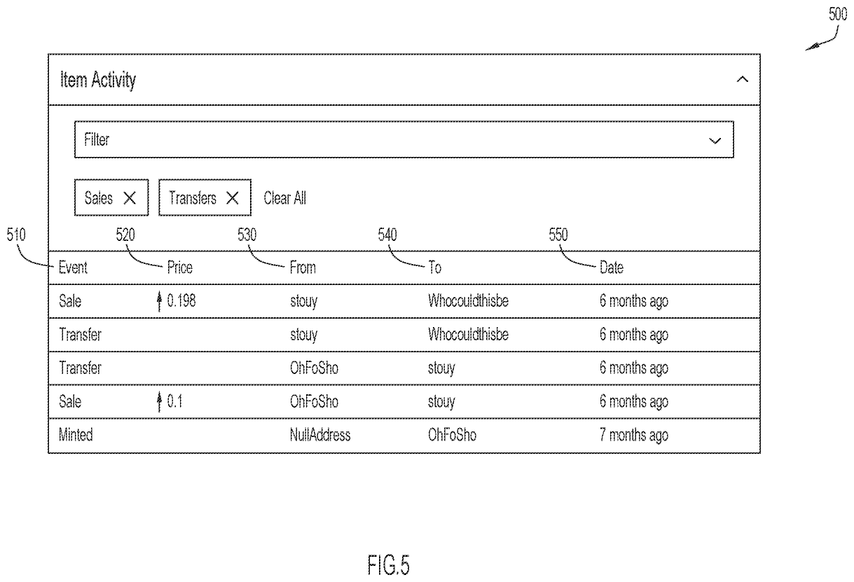

FIG. 5 is a schematic illustration of an example graphical user interface 500 for displaying wallet activity according to an embodiment of the present invention. As depicted, graphical user interface 500 corresponds to a particular wallet, and includes an event field 510, a price field 520, a sender field 530, a recipient field 540, and a date field 550. Wallet transactions can be described according to the values indicated by the fields.

Event field 510 may describe a category or nature of each transaction. In particular, a transaction can be a purchase event, transfer event, minting event, and the like. A purchase event may indicate that an NFT was transferred in exchange for a monetary value, which can be accomplished by exchanging a sum of cryptocurrency coins for the NFT. A transfer event may indicate that an NFT was moved from one wallet to another without an exchange of cryptocurrency coins, and a minting event can indicate that a user minted the particular NFT. In the case of a purchase event, price field 520 can indicate the sum of cryptocurrency that was exchanged for the NFT.

Sender field 530 and recipient field 540 together describe the participants of a transaction. The contents of sender field 530 and recipient field 540 can be analyzed to determine whether a transaction involves a user whose profile is being tracked for badging purposes. Date field 550 provides a date of the transaction, either as a timestamp or as an amount of time that has elapsed since the transaction.

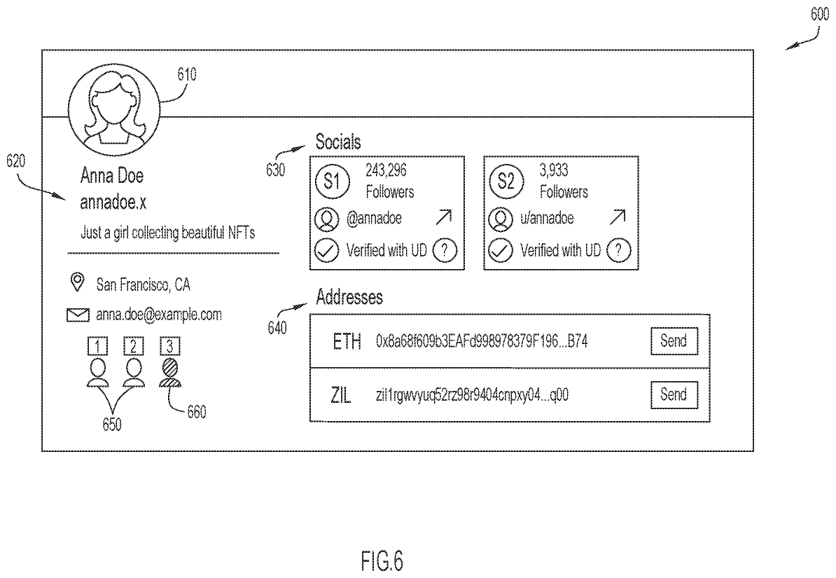

FIG. 6 is a schematic illustration of an example graphical user interface 600 for displaying a user profile according to an embodiment of the present invention. As depicted, graphical user interface 600 includes a user icon 610, a bibliographical section 620, social media accounts 630, wallet addresses 640, and badges 650 and 660.

User icon 610 may include an avatar, photograph of the user, placeholder image, or any other desired representation of a user. Bibliographical section 620 may include details that a user provides about the user, such as a custom description, background, education, and the like. Social media accounts 630 may include one or more social media accounts of the user, and wallet addresses 640 may include one or more receiving addresses for one or more wallets, which the user may register with the user's profile, and which may be tracked in accordance with present embodiments in order to support a badging system.

Badges 650 and 660 may include badges that indicate a status of the corresponding NFTs. As depicted, badges 650 may include badges that correspond to NFTs that are currently owned by the user. Accordingly, badges 650 may be depicted as fully saturated, may be depicted as a particular color (e.g., green), and the like. In contrast, badge 660 may correspond to an NFT that the user no longer owns. As such, badge 660 may be depicted as a greyed-out badge, a hollow badge (e.g., just an outline of a badge), a particular color (e.g., a red badge), and the like.

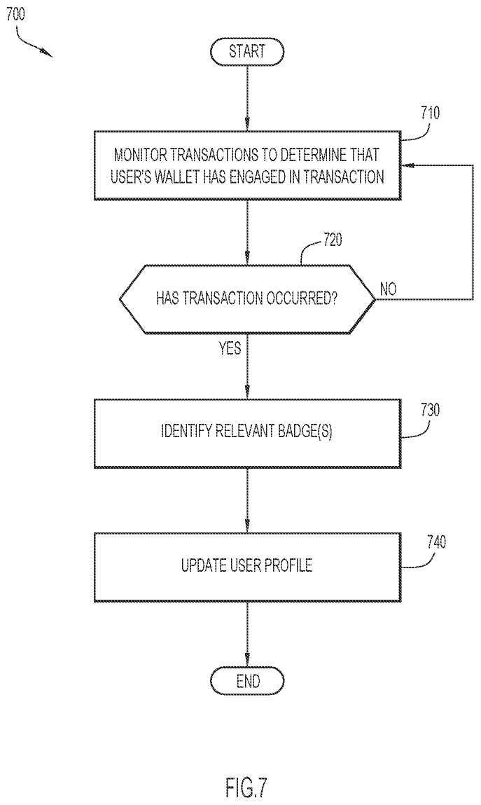

FIG. 7 is a flowchart of a method 700 of managing user badges according to an embodiment of the present invention.

Blockchain transactions are monitored at operation 710 to determine that a user's wallet has engaged in a transaction. A service (e.g., monitoring module 140) can monitor a blockchain and compare the participants of each transaction against a list of users' registered wallet addresses to evaluate whether a transaction involves a user. The service may monitor a blockchain by analyzing the blockchain periodically (e.g., according to a predefined schedule), or the service may monitor the blockchain in real-time as new blocks are added, or the service may analyze the blockchain in response to a predefined or user-defined event (e.g., at account creation, at a user's request, etc.). In some embodiments, the service may monitor multiple blockchains (e.g., a Bitcoin blockchain and an Ethereum blockchain).

Operation 720 determines whether a transaction involving a user has occurred. If the sender or recipient matches a wallet address of a user, then one or more relevant badges are identified at operation 730. Otherwise, the service continues to monitor the blockchain.

The one or more relevant badges can be identified based on conditions defined for each badge. The condition can include receiving of an NFT, sending of an NFT, a user wallet having a particular number of NFTs, either total or in a particular category, and the like. In some embodiments, the conditions may be satisfied based on wallet activity in combination with other events, such as the activity occurring at a particular time, the other participant in the transaction having a particular identity, the amount of cryptocurrency coins offered in exchange for an NFT, and the like. A single transaction may involve one badge or multiple badges. The badges that are identified as relevant may include badges that are already associated with the user's profile and/or badges that are not yet associated with the user's profile.

The user profile is updated at operation 740. The profile can be updated by adding, modifying and/or removing the one or more relevant badges. In the case that a user has acquired an NFT, a badge (or multiple badges) may be added to the user's profile. Similarly, in the case that a user has transferred ownership of an NFT to another, a badge may be removed or replaced with a greyed-out badge.

A badge that is associated with a user profile can be optionally persisted to one or more storage locations. In some embodiments, a user's association with a badge can be stored to a blockchain, such as the blockchain hosting the NFT transaction or a separate blockchain. In some embodiments, the badge association may be stored to an off-chain database (e.g., database 145) so that a user's status with respect to a badge can be quickly retrieved by a requesting service. In some embodiments, the user's association with a badge can be cached wherever a user interface displaying the badge is displayed (e.g., in a browser cache of an endpoint device).

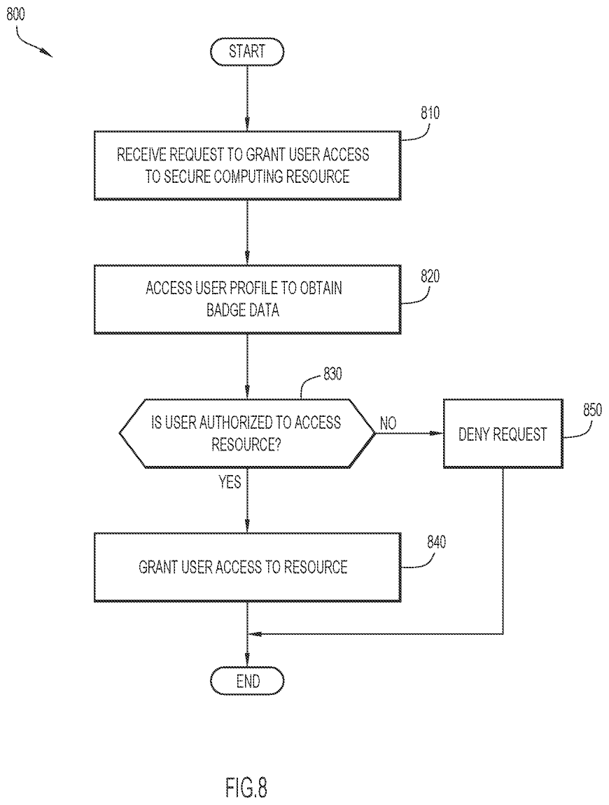

FIG. 8 is a flowchart of a method 800 of authorizing user access to a computing resource according to an embodiment of the present invention.

A request to grant a user access to a secure computing resource is received at operation 810. The secure computing resource may include a network, a storage device, a computing system, or combinations thereof. When the request is received, a computing device tasked with authorizing users may receive the request, which can include an identity of the user (e.g., a username).

The user profile is accessed to obtain badge data at operation 820. The computing device tasked with authorizing users may access, via the identity of the user, the user profile that indicates the badges that are associated with the user. In some embodiments, the user profile data is hosted by a system (e.g., server system 125) that is accessible via an Application Programming Interface (API). In some embodiments, the badge data is accessed from a blockchain on which associations between a user and badge statuses are stored.

Operation 830 determines whether the user is authorized to access the secure computing resource. Access may be granted based on the presence or absence of particular badges, counts of badges, number or identity of badges previously owned, maximum number of badges ever owned, and the like. If it is determined that access should be granted based on a user's badge data, then the user is granted access to the computing resource at operation 840. Otherwise, then the user is denied access at operation 850, and a message indicating that access is denied may optionally be transmitted to a device of the user.

It will be appreciated that the embodiments described above and illustrated in the drawings represent only a few of the many ways of implementing embodiments for profile badges and access control based on digital wallet activity. In addition, characteristics or features of embodiments of the present invention may be combined in any fashion to provide additional embodiments of the present invention.

The environment of the present invention embodiments may include any number of computer or other processing systems (e.g., client or end-user systems, server systems, etc.) and databases or other repositories arranged in any desired fashion, where the present invention embodiments may be applied to any desired type of computing environment (e.g., cloud computing, client-server, network computing, mainframe, stand-alone systems, etc.). The computer or other processing systems employed by the present invention embodiments may be implemented by any number of any personal or other type of computer or processing system (e.g., desktop, laptop, hand-held devices, smartphones or other mobile devices, etc.), and may include any commercially available operating system and any combination of commercially available and custom software (e.g., communications software; server software; software of present invention embodiments (including browser module 115, blockchain client module 120, profile management module 135, monitoring module 140, etc.), etc.). These systems may include any types of monitors and input devices (e.g., keyboard, mouse, voice recognition, etc.) to enter and/or view information.

It is to be understood that the software of the present invention embodiments (e.g., browser module 115, blockchain client module 120, profile management module 135, monitoring module 140, etc.) may be implemented in any desired computer language and could be developed by one of ordinary skill in the computer arts based on the functional descriptions contained in the specification and flowcharts illustrated in the drawings. Further, any references herein of software performing various functions generally refer to computer systems or processors performing those functions under software control. The computer systems of the present invention embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.). For example, the functions of the present invention embodiments may be distributed in any manner among the various end-user/client and server systems, and/or any other intermediary processing devices. The software and/or algorithms described above and illustrated in the flowcharts may be modified in any manner that accomplishes the functions described herein. In addition, the functions in the flowcharts or description may be performed in any order that accomplishes a desired operation.

The software of the present invention embodiments (e.g., browser module 115, blockchain client module 120, profile management module 135, monitoring module 140, etc.) may be available on a non-transitory computer useable or readable medium (e.g., magnetic or optical mediums, magneto-optic mediums, CD-ROM, DVD, memory devices, etc.) of a stationary or portable computer program product, apparatus, or device for use with stand-alone systems or systems connected by a network or other communications medium.

The communication network may be implemented by any number of any type of communications network (e.g., LAN, WAN, Internet, Intranet, VPN, etc.). The computer or other processing systems of the present invention embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., local area network (LAN), hardwire, wireless link, Intranet, etc.).

The system may employ any number of any conventional or other databases, data stores or storage structures (e.g., files, databases, data structures, data or other repositories, etc.) to store information (e.g., user profile data, badge status data, NFT data, wallet data, access permission data, etc.). The database system may be implemented by any number of any conventional or other databases, data stores or storage structures to store information. The database system may be included within or coupled to the server and/or client systems. The database systems and/or storage structures may be remote from or local to the computer or other processing systems, and may store any desired data.

The present invention embodiments may employ any number of any type of user interface (e.g., Graphical User Interface (GUI), command-line, prompt, etc.) for obtaining or providing information (e.g., user profile data, badge status data, NFT data, wallet data, access permission data, etc.), where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

The present invention embodiments are not limited to the specific tasks or algorithms described above, but may be utilized for verifying any entity's ownership of digital items and/or selectively authorizing access based on ownership status of the items.

The data (e.g., user profile data, badge status data, NFT data, wallet data, access permission data etc.) may have any form or format, and may include any quantity of terms, words, tokens, or arrangements of any quantity of elements (e.g., alphanumeric or other characters, symbols, numbers, etc.).

The data that is associated with an NFT can include any data, including text, graphical data, audio data, video data, and the like. The data can be encrypted/decrypted according to any conventional or other encryption/decryption algorithm, and may be compressed/decompressed prior to encryption and/or storage on another storage medium. The access permissions for users and/or the conditions to associate badges with users can include any criteria, including requesting entity identity criteria, time-based criteria, location-based criteria, use case criteria, data type criteria, NFT identity criteria, NFT type criteria, or other criteria.

A blockchain network that is used to store user data can include any distributed ledger, including a Bitcoin blockchain, an Ethereum blockchain, a Cardano blockchain, or other blockchain network, including private, public, and hybrid networks. The blockchain network may utilize any protocol or combination of protocols, and consensus for stored data may be achieved using any conventional or other consensus mechanism. Data stored to the blockchain may be mirrored in one or more conventional databases at the time of storage or periodically to provide a cached data store that can be accessed more quickly.

Having described preferred embodiments of a new and improved system, method, and computer program product for controlling access to computing resources and tracking wallet activity using user profile badges, it is believed that other modifications, variations and changes will be suggested to those skilled in the art in view of the teachings set forth herein. It is therefore to be understood that all such variations, modifications and changes are believed to fall within the scope of the present invention embodiments as defined by the appended claims.

What is claimed is:

1. A method of monitoring blockchain activity comprising:
determining, via at least one processor, that a wallet associated with a user has engaged in a transaction on a blockchain;
identifying, via the at least one processor, a badge of a plurality of badges based on the transaction; and
updating, via the at least one processor, a profile of the user to include the badge to indicate a user status for activity on the blockchain.

2. The method of claim 1, further comprising:
in response to determining that the profile of the user includes the badge, authorizing a request by the user to access a computing resource.

3. The method of claim 1, further comprising:
determining, via the at least one processor, that the wallet has engaged in a subsequent transaction involving a component of a previous transaction; and
updating, via the at least one processor, the profile of the user to modify or remove the badge associated with the previous transaction.

4. The method of claim 1, wherein the transaction is selected from a group of: a cryptocurrency transaction, and a non-fungible token transaction.

5. The method of claim 1, wherein the badge is associated with the transaction according to a predefined association.

6. The method of claim 1, wherein the badge comprises a placeholder badge that is selected in response to no predefined badge being associated with the transaction.

7. The method of claim 1, wherein the badge is identified further based on a count of items stored in the wallet.

8. A system for monitoring blockchain activity comprising:
one or more memories; and
at least one processor coupled to the one or more memories, the at least one processor configured to:
determine that a wallet associated with a user has engaged in a transaction on a blockchain;
identify a badge of a plurality of badges based on the transaction; and
update a profile of the user to include the badge to indicate a user status for activity on the blockchain.

9. The system of claim 8, wherein the at least one processor is further configured to:
in response to determining that the profile of the user includes the badge, authorize a request by the user to access a computing resource.

10. The system of claim 8, wherein the at least one processor is further configured to:
determine that the wallet has engaged in a subsequent transaction involving a component of a previous transaction; and
update the profile of the user to modify or remove the badge associated with the previous transaction.

11. The system of claim 8, wherein the transaction is selected from a group of: a cryptocurrency transaction, and a non-fungible token transaction.

12. The system of claim 8, wherein the badge is associated with the transaction according to a predefined association.

13. The system of claim 8, wherein the badge comprises a placeholder badge that is selected in response to no predefined badge being associated with the transaction.

14. The system of claim 8, wherein the badge is identified further based on a count of items stored in the wallet.

15. A computer program product for monitoring blockchain activity, the computer program product comprising one or more computer readable media having instructions stored thereon, the instructions executable by at least one processor to cause the at least one processor to:
determine that a wallet associated with a user has engaged in a transaction on a blockchain;
identify a badge of a plurality of badges based on the transaction; and
update a profile of the user to include the badge to indicate a user status for activity on the blockchain.

16. The computer program product of claim 15, wherein the instructions executable by at least one processor further cause the at least one processor to:
in response to determining that the profile of the user includes the badge, authorize a request by the user to access a computing resource.

17. The computer program product of claim 15, wherein the instructions executable by at least one processor further cause the at least one processor to:
determine that the wallet has engaged in a subsequent transaction involving a component of a previous transaction; and
update the profile of the user to modify or remove the badge associated with the previous transaction.

18. The computer program product of claim 15, wherein the transaction is selected from a group of: a cryptocurrency transaction, and a non-fungible token transaction.

19. The computer program product of claim 15, wherein the badge is associated with the transaction according to a predefined association.

20. The computer program product of claim 15, wherein the badge comprises a placeholder badge that is selected in response to no predefined badge being associated with the transaction.

21. The computer program product of claim 15, wherein the badge is identified further based on a count of items stored in the wallet.
